(19) United States
(12) Patent Application Publication
(10) Pub. No.: US 2012/0173293 A1
(43) Pub. Date: Jul. 5, 2012

(54) Systems and Methods for Carbon Emission Calculation, Tracking and Analysis

(76) Inventors: John Motley, Rumson, NJ (US); Jonathan O'Keeffe, Amherst, MA (US)

(21) Appl. No.: 12/982,425

(22) Filed: Dec. 30, 2010

(51) Int. Cl. G06Q 10/00

(52) U.S. Cl. 705/7.11

(57) ABSTRACT

A system and method for determining and reducing carbon emissions associated with the transportation of products around the world. An origin, a load, a discharge and a destination are entered on a computer interface. A processor determines carbon emissions for a plurality of routes from the origin to the destination using the origin, the load, the discharge, and the destination to determine and by considering one or more legs from the origin to the destination and by considering a plurality of modes of transportation for each of the legs. The processor determines which of the plurality of routes and which of the plurality of mode of transportations will generate the least carbon emission. A variety of parameters, including but not limited to, vehicle type, fuel time, arrival/departure times, can also be considered in determining carbon emissions. The route with the least carbon emissions can be graphically displayed. Additionally, other alternate routes can also be displayed.

### BACKGROUND

Carbon emissions are a well known problem. Transporting cargo around the world is a large contributor to the problem of carbon emissions. There are different modes of transportation available, including motorize transportation on land, rail transportation and ocean transportation. There are also a variety of routes that cargo can take when being transported. Accordingly, there are many variables to consider when planning the transportation of cargo if carbon emissions are to be considered.

Entities are starting to consider carbon emissions when planning to transport their cargo. Existing applications to consider carbon emissions while planning, or auditing, transportation, however, are not adequate. They fail to provide adequate capabilities to allow entities to plan, or audit, a transportation of a product from an overseas location to a local market while trying to reduce carbon emissions. They also fail to adequately track total carbon emissions.

As a result of these and other deficiencies, new and improved methods and systems to analyze and track carbon emissions are needed.

### SUMMARY

In accordance with one aspect of the present invention, methods and apparatus are provided for planning the transportation of freight in view of the carbon emissions associated with the transportation of the freight over multiple routes and with multiple possible modes of transportation. It can also be used to determine actual carbon emissions used when transporting freight.

In accordance with one aspect, a method of calculating carbon emissions when transporting freight is provided including the steps of entering an origin and a destination on a computer interface and storing the origin and the destination in a memory. Then a processor reads the origin and the destination in the memory and determines carbon emissions when transporting the freight from the origin to the destination by considering a plurality of modes of transporting the freight. Then the processor determines which of the plurality of modes of transporting the freight will generate the least carbon emission. The processor can also cause the route and mode of transporting the freight that will generate the least carbon emission.

In accordance with an aspect of the present invention, the plurality of modes of transporting the freight that are considered by the processor includes motorized land transportation, ocean transportation, rail transportation and air transportation.

In accordance with a further aspect of the present invention, the processor determines carbon emissions for a plurality of possible routes from the origin to the destination using at least two of the plurality of modes of transporting the freight for each of the plurality of possible routes and then determines which of the plurality of possible routes will generate the least carbon emission.

A user of the system providing the method can also enter a load and discharge location on the computer interface and store the load and discharge location in the memory. The processor can use the load and discharge location to determine carbon emissions for the plurality of possible routes from the origin to the destination using at least two of the plurality of modes of transporting the freight for each of the plurality of possible routes and then determines which of the plurality of possible routes will generate the least carbon emission using the load and discharge location.

The method in accordance with a further aspect of the present invention, can further include repeating the steps of claim 1 for one or more additional origins and destinations, then summing the total carbon emissions from each origin and destination and storing the sum in the memory.

When performing its processing steps, the processor can also considering vessel/vehicle type, fuel used, vessel/vehicle loading, arrival time and departure time for each of the plurality of routes to determine which route will generate the least carbon emissions. The processor can also consider power consumption and methods used during time in port when considering ocean transportation.

These steps can be performed for each piece of freight transported by an entity. In accordance with an aspect of the present invention, the processor determines a total carbon emissions by an entity by summing the total carbon emissions for each freight transportation recorded in the system.

In accordance with a further aspect of the present invention, a user can enter a product associated with each origin and destination which is stored in memory. The processor can then access the information and determine the total carbon emission by product over a preselected period of time.

Similarly, supplier information associated with each origin and destination can be entered and stored. The processor can use this information to determine the total carbon emission by supplier over a period of time.

The processor can also determine the total carbon emission by mode of transportation for an entity over a period of time by accessing historical records of the entity's transportation of freight.

The carrier associated with each origin and destination can also be entered and stored. The processor can use this information to determine the total carbon emission by carrier over a period of time.

A system providing carbon rating and audit of large sets of shipments of goods moved over a period of time with each unit transported being evaluated through the same process noted above to determine an entities total carbon emission, total carbon credits or total carbon liability.

A system implementing these steps is also contemplated. As described herein the system can either be internet based or used on a stand-alone computer. The system can also be implemented on a more limited network, such as an intranet.

### DRAWINGS

FIGS. 1 and 2 illustrate the overall process in accordance with one aspect of the present invention.

FIGS. 3 and 4 illustrate systems on which the present invention can be implemented in accordance with various aspects of the present invention.

FIGS. 5 and 6 illustrate user interfaces in accordance with various aspects of the present invention.

FIGS. 7 and 8 illustrate flow diagrams associated with the process performed by the processor to determine optimal routes and to determine carbon emissions for each route.

FIGS. 9 to 14 illustrate various reports that can be generated in accordance with various aspects of the present invention.

### DESCRIPTION

In accordance with an aspect of the present invention, a Carbon Calculator that calculates carbon dioxide emissions for intermodal freight movements anywhere in the world is provided. Complex international supply chains can involve many variables, and each of these variables can have an impact on the overall emissions created by the freight movement. The system and method of the present invention allows the examination of the impact these variables have, helping to build a more sustainable supply chain.

In accordance with an aspect of the present invention, the first step in using the Carbon Calculator is to enter the locations for your freight movement on a computer interface. Location fields can be left blank if the associated freight movement does not include certain types of locations or a fewer set of interchange points.

After entering location data, additional details about transport modes and specific transport parameters can be entered. Then a Calculate Carbon Emissions button is pressed on the computer interface to see the overall carbon footprint of freight movement. Alternatively, if a larger set of movements is uploaded in to the interface the entire set of movements will be considered and rated for carbon emission by location, mode, carrier and other user defined parameters. Reports, as discussed later, can also be generated from the uploaded data.

Mode selection can be a critical issue. For example, the selection of transport modes can play a critical role in determining emission levels for international shipments. Different combinations of transport modes for a trip from the same origin to the same destination can yield substantially different emission levels.

The present invention allows for Inland Mode Selection. While many countries are constrained in their ability to provide efficient inland transportation to and from port areas via rail, it is a much more carbon-efficient mode of transport and usually is much more cost effective.

Countries developing their inland rail networks, particularly their intermodal stacked container rail services, will greatly reduce their levels of emissions. Modem intermodal transfer facilities which interchange ocean containers to and from rail movement enable rail alternatives that can have equal transit times with much lower fuel consumption. Intermodal rail has the added benefit of reducing road congestion.

The present invention allows for evaluating the impact of where cargo is interchanged between modes of transportation. Because of the tremendous carbon efficiency of ocean transportation in many instances it is more carbon efficient for cargo to interchange to US Midwest locations via the US East Coast even if the goods originate in north Asia and must transit the Panama Canal to do so.

The present invention also allows for Intercontinental Mode Selection. For long distance voyages, the faster transit times of air shipments come at a price of greatly increased emission levels. Air shipments can generate emissions approximately five times higher than those generated by an ocean voyage for the same set of cargo. Aircraft emissions also have a greater effect due to their occurrence at high altitudes, where they can trigger a set of chemical reactions that magnifies their impact. Organizations have estimated that the climate impact of air transport is two to four times greater than the effect generated by the carbon dioxide emissions alone.

Routing and Route Selection is an important criteria. For all modes of travel, emission levels are strongly dependent on the distance traveled by the transport vehicle. The Carbon Calculator of the present invention can model these distances in various ways, depending on the mode of transport.

Ocean Transportation is another important mode of transporting freight. Ocean voyage distances are built around standard international trade lanes, using great-circle distances to measure long open-water segments of the voyage, and routing around land masses and through canals, where available. In accordance with an aspect of the present invention, a routing database is included that includes information about specific port locations and approaches for many of the world's largest container ports, and these port-specific routing features are part of the distance calculation between various pairs of ports.

Motor transportation is another important mode of transportation. In accordance with one aspect of the present invention, distances traveled by motor transport over the public highway infrastructure are calculated by actual on-the-road distance measurements using the shortest available route between the two locations. Motor routing data is available for many countries worldwide, including most major importers and exporters of international container shipments. or countries where road routing information is not available, the straight-line distance between the locations can be used as a starting point, and modified by a constant factor to approximate the extra distance traveled over the roadways.

Rail transportation is another important mode of transportation. The exact distance traveled by rail shipments depends on the details of the rail network used by the particular carrier, and this data is generally not available for specific arbitrary pairs of locations. Instead, the Carbon Calculator of the present invention calculates the average factors by which rail distances typically exceed straight-line distances, based on available rail data in the United States, Europe, and Asia. These factors, or actual data when available, are used to estimate the rail distance between any pair of locations, based on the straight-line distance between the locations.

Air transportation is another important mode of transportation. In accordance with one aspect of the present invention, the Carbon Calculator models air transport distances using a straight-line, great-circle distance between the origin and destination. This distance is also known as orthodromic distance. This method of calculating distance is known. Actual routes flown by commercial transport aircraft may differ from the straight-line distance based on current weather conditions and seasonal climate patterns, but distances are generally quite close to the straight-line distance.

The present invention also recognizes Vessel Size to be another important factor to consider in determining carbon emissions. Vessel classes can be categorized in terms of their evolution over the past 10 to 15 years. Older vessels capable of carrying 6,000 Twenty Foot Equivalent Units (TEUs) are being replaced by vessels able to carry 8,000 or 10,000 TEU. Most of these ships have engines of 40,000 to 60,000 horsepower. As a result the work that the engine performs has been able to move more and more containers per unit of fuel burned, and subsequently, carbon dioxide emitted. Many very large vessels cannot transit the Panama Canal. These vessels exceed the width of the canal. The present invention accounts for the routes these vessels must take. Large ocean going vessels also have auxiliary power plants for electrical and hotel services on board the vessel. The present invention accounts for this auxiliary power as well.

Arrivals and departures can be one of the most carbon-costly portions of a journey in any mode of transport. Vessels maneuver in and out of port, flights bum more fuel taking off and landing, and rail engines burn more fuel per unit as they maneuver to efficient operating speeds on their primary routes. The Carbon Calculator, in accordance with one aspect of the present invention, models these effects, and their impact on emission levels. The effect of arrivals and departures is particularly evident for air transport, where fuel consumption during takeoff and climb to cruising altitude can be up to ten times greater than that consumed during level flight. As a result, short-distance air journeys result in a significantly higher level of emissions per unit distance, as compared to longer journeys.

Type of Fuel is another important factor in determining carbon emissions. The Carbon Calculator of the present invention, in accordance with one aspect of the present invention, can use a model that considers that different types of fuel used by the engines in various forms of transport vehicles. Jet fuel, light diesel and heavy diesel are each composed of hydrocarbon molecules with different numbers of carbon atoms. Each fuel will thus generate a different volume of CO2 for each ton of fuel burned. This is accounted for by the present invention.

For ocean transport, one important factor is the amount of time spent in port, or dwell time. During this period, the vessel must use smaller, less-efficient auxiliary power generators, or shore power, in order to continue to operate. Larger vessels spend more time in port loading and unloading than smaller vessels, and port operations can also generate substantial CO2. In accordance with one aspect of the present invention, the Carbon Calculator models the impact of emissions generated during a vessel's time in port, including the additional time required to service larger vessels.

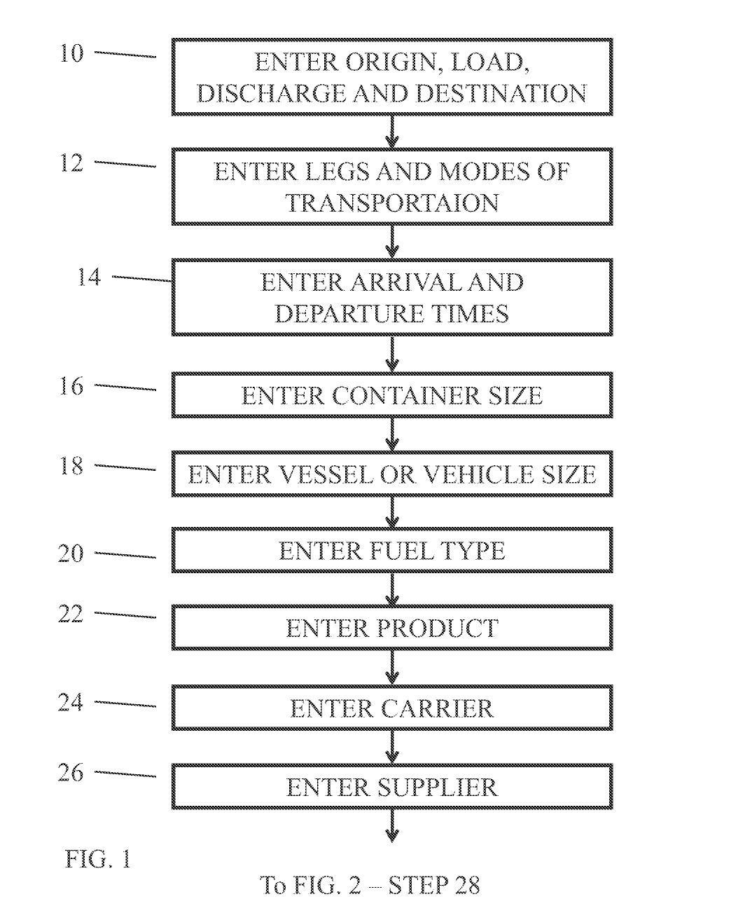

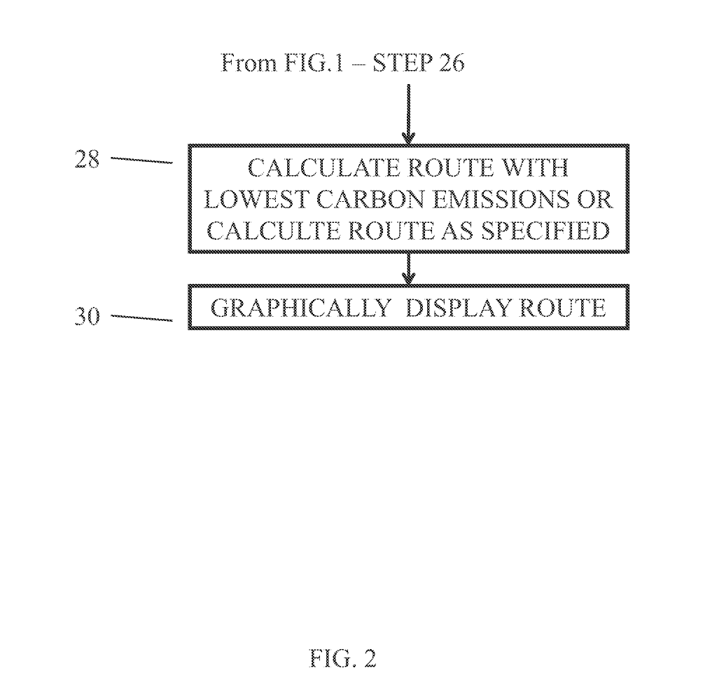

The overall process, in accordance with one aspect of the present invention, is illustrated in the flowchart of FIGS. 1 to 2. In step 10, a user enters the origin and destination of the freight on an interface on a computer display, thereby stating the starting point and then end point over which the freight will be transported. In step 10, a user can also enter a load and a discharge. The load and discharge points are interchange locations where cargo will typically transition from one mode of transport to another. The cargo will be loaded on to a vessel, plain, truck, barge, train, etc. at the load port. The cargo will be discharge from that vehicle to another mode of transport at the discharge point or port.

In step 12, the user can optionally enter the legs and modes of transportation for each leg. Thus, in step 12, a variety of legs from an origin to a destination can be entered. Additionally, for each leg, a plurality of modes of transportation can be selected. Of course, the modes of transportation that are selected can be limited to those that make sense. For example, inland transportation can be limited to motorized trucking and rail. Of course, if various water routes are available through canals by example, those routes can be included as options. Air transportation could also be included. If the user does not specify the modes of transportation, the processor can consider the various possibilities for each leg to determine the optimum transportation from the perspective of carbon emissions.

In step 14, the user can optionally enter arrival and departure times for each leg of the transportation, if known. The arrival and departure times can affect carbon emissions. For example, if ocean transportation is used, then the time the vessel arrives at a port will have an effect on the dwell time the vessel spends in port. Likewise, if a vessel is departing during a busy time in port, it will also affect carbon emissions. Additionally if the vehicle transporting the goods moves between the departure and arrival location at higher speed, the higher load factor on the engine will result in a larger amount of carbon being generated at potential less efficient fuel consumption rates. This information, if known, can be entered for each leg of the transportation of the freight.

In step 16, the user can optionally enter the container size and the number of containers being used to transport the freight. In this step, the user can also enter the percent utilization of the vessel. Knowing the size of the vehicle and the percentage utilization, the system is able to determine the total number of units being transported in terms of TEU or kilograms of freight moved. After the total carbon emission of the vehicle is calculated the emission is then allocated to the portion of the cargo on the vehicle moved by the user evaluating the transportation. For example a vessel of 10,000 TEU may only be 80% full. Subsequently the correct allocation of the carbon for the user evaluating the portion of the vehicles carbon used for their goods would divide their volume of TEU by 8,000 instead of the full capacity of the vehicle. This information, if known, can be entered for each leg of the transportation of the freight.

In step 18, the user can optionally enter the vessel being used or the vehicle size, including the engine being used. The vessel size, vehicle size and the engine size has a definite effect on the carbon emissions. Generally, the bigger the vessel, vehicle or engine, the greater the carbon emissions. This information, if known, can be entered for each leg of the transportation of the freight.

In step 20, the user can optionally enter the fuel type being used. Generally, a drop down list box is provided that indicates the various fuel types available. For example, the drop down list box for inland motorized transportation can indicate gasoline or various grades of diesel, liquefied natural gas, ethanol based fuels or other fuel types as choices. Other choices can be provided for other modes of transportation. If a bulk set of movements is being evaluated this can be provided in the input file or derived. This information, if known, can be entered for each leg of the transportation of the freight.

In step 22, the user can optionally enter the product being transported. This information will generally be the same for each leg of the transportation of the freight.

In step 24, the user can optionally enter the carrier transporting the freight. This information, if known, can be entered for each leg of the transportation of the freight.

In step 26, the user can enter the supplier, or other additional attributes of the product the user would like to audit or analyze, of the product being transported. This information will be the same for each leg of the transportation of the freight.

After this information has been entered, a processor can perform different calculations. If a user has entered an origin and destination, little or no other information, the processor can consider different legs of transporting the freight from the origin to the destination and different modes of transportation, including land motorized, rail, ocean and air, for each of the legs. For example, if the freight is to be transported from a factory located in inland China to New York, the processor can consider various routes from the factory to various ports (sea and airports) in China. The processor can also consider motorized transportation or rail transportation. It can calculate carbon emissions for each of those routes.

Then, based on the possible routes from the Chinese factory to the Chinese port, it can calculate various routes from the Chinese port to the New York port. These can include air transportation, including a variety of air routes. The various routes can also include a variety of ocean transportation routes. For example, the ocean routes can go through available canals or be routed around continents. The processor determined the carbon emissions for each of these routes.

Then the processor determines a variety of routes from the New York port to the inland New York warehouse where the freight will be stored. As it did with respect to transportation of the freight in China, the processor considers various routes from the New York port to the inland New York warehouse. It will consider various trucking routes, rail routes, air routes and water routes as available. For each of the routes, the processor will determine the carbon emissions.

Then the processor considers all of the possibilities of transporting the freight from the inland Chinese factory to the New York warehouse and determines the carbon emissions for each of the routes from the inland Chinese factory to the New York warehouse. The processor then determines which route has the lowest carbon emissions. The route with the lowest carbon emissions, and the associated details, are preferably displayed graphically to the user. The other routes considered by the processor can also be displayed graphically when the user desires to see the alternatives.

In making these calculations, the processor can consider all of the parameters previously described. If the user specifies any of these parameters, the processor can optionally consider them in its calculations. If the user does not specify them, then the processor can access its own database of information, if available, and use information from its database in its calculations. Thus, for example, the processor can consider possible arrival and departure times. It can consider various container sizes. The user should, however, specify the number of containers. The processor can consider various vessels or other vehicles that could be used. It can consider the percentage utilization of each vehicle, taking an average if it is unknown. The processor can consider various fuel types that could be used.

Thus, the processor considers all or some of these parameters for each route (or leg) and for each mode of transporting the freight for each route and determines the route and the mode of transportation with the lowest carbon emission, as illustrated in step 28 in FIG. 2. Then, in step 30, the processor causes the route from the inland Chinese factory to the inland New York warehouse with the lowest carbon emissions to be displayed. Upon request by the user, alternate routes considered by the processor, along with the total carbon emissions and the carbon emissions along each leg, can also be graphically displayed to the user.

The processor can also determine carbon emissions based on the information entered by the user. This can be used, for example, for planning purposes. Thus, if the user enters the ports to be used, then the processor can use that information to generate the route with the lowest possible carbon emission. In accordance with another embodiment of the present invention, the processor can also consider other possible routes (outside those specified by the user) and alert the user that there may be alternate routes and alternate modes of transporting the freight that will provide lower carbon emissions.

In summary, the processor starts with the origin and destination, and can use all or some of the parameters described above, whether entered by a user or provided as possibilities from a database the processor has access to, to provide the carbon emissions that transporting freight from the origin to the destination will cause. It can also be used for planning purposes to determine the optimal route in terms of lowest carbon emissions. It can also be used for auditing and reporting purposes to determine total carbon emissions, carbon credits or carbon liability.

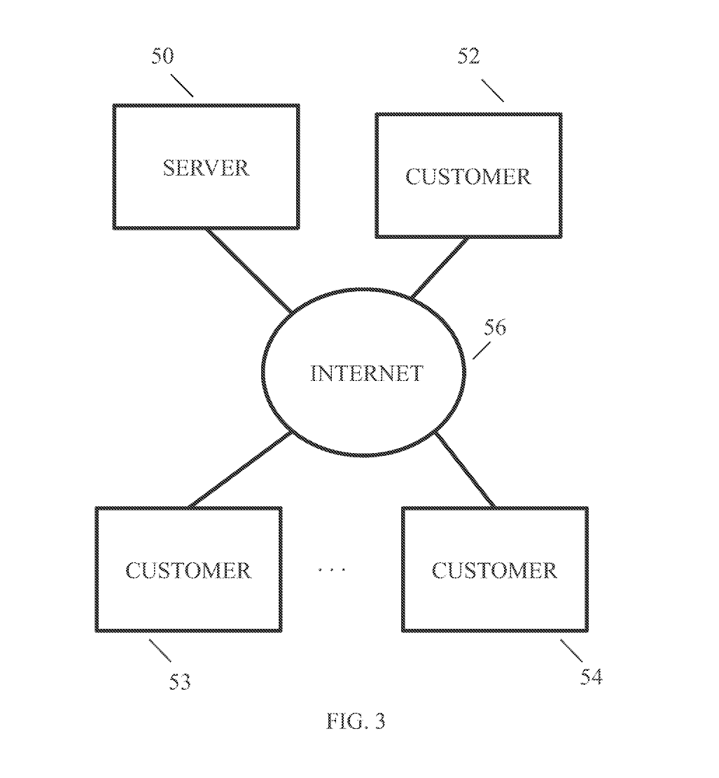

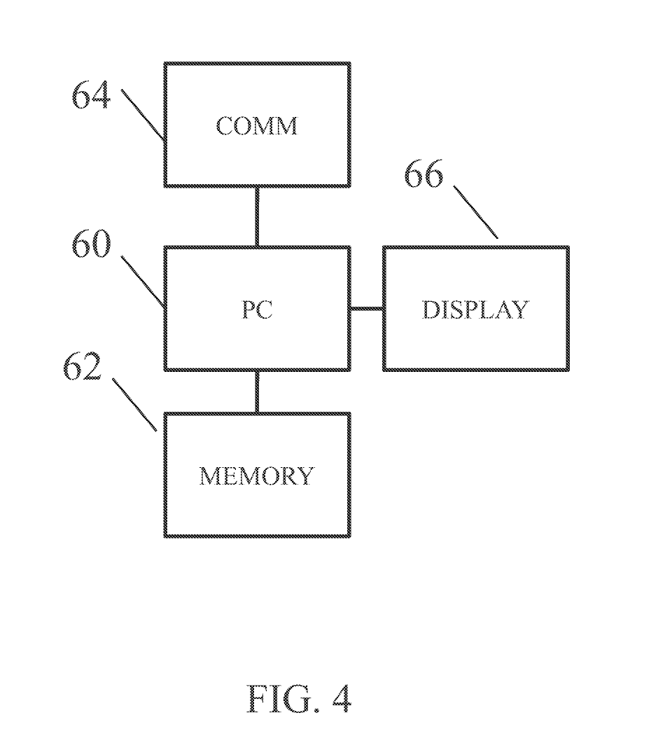

Systems on which the present invention can be implemented in accordance with various aspects of the present invention are illustrated in FIGS. 3 and 4. The system can either be an internet based system or a standalone system. Thus, a user can access a website hosting the processor that calculates carbon emissions from a remote computer over the internet. Application activities can be divided between the website and the remote computer in any number of possible, well-known ways. Alternatively, the steps described herein can be provided on a stand-alone processing system.

FIG. 3 illustrates the internet based implementation. A server 50 hosts the application, the processors, the memory and the database of transportation information needed to implement the previously described steps. Various customers 52 to 54 access the server 50 through the internet 56 or any other network and the steps described above are performed. Thus, the desired user interface is provided on the customer computer 52 to 54, the user enters the desired information on the user interface on the computers 52 to 54, and that information is transmitted to the server 50 via the network 56. The processor at server 50 performs calculations described above by either using the information provided by the customer, or by accessing information on a database maintained at the server 50 or both and then provides routing information and associated carbon emission information back to the customer 52 to 54. The customer can then plan the transportation of the freight accordingly.

FIG. 4 illustrates a stand-alone computing system that can also be used. The stand-alone computer includes a processor 60, a memory 62, a communications circuit 64 and a display 66. Such arrangements are extremely well known. The software application that implements the steps described above are stored in the memory 62. The database of information used by the processor 60 to perform the steps is also stored in the memory 62. The processor causes a user interface to be displayed on the display 66 in accordance with software instructions received from the memory 62. The user enters information into the user interface and that information is stored in the memory 62. The processor accesses the user specified information and, to the extent necessary, the carbon emission information for various possible routes that are stored in the database in the memory 62 to perform that carbon emissions calculations described above.

The system of FIG. 4 can also be used to implement the various computers 50 and 52 to 54 of FIG. 3.

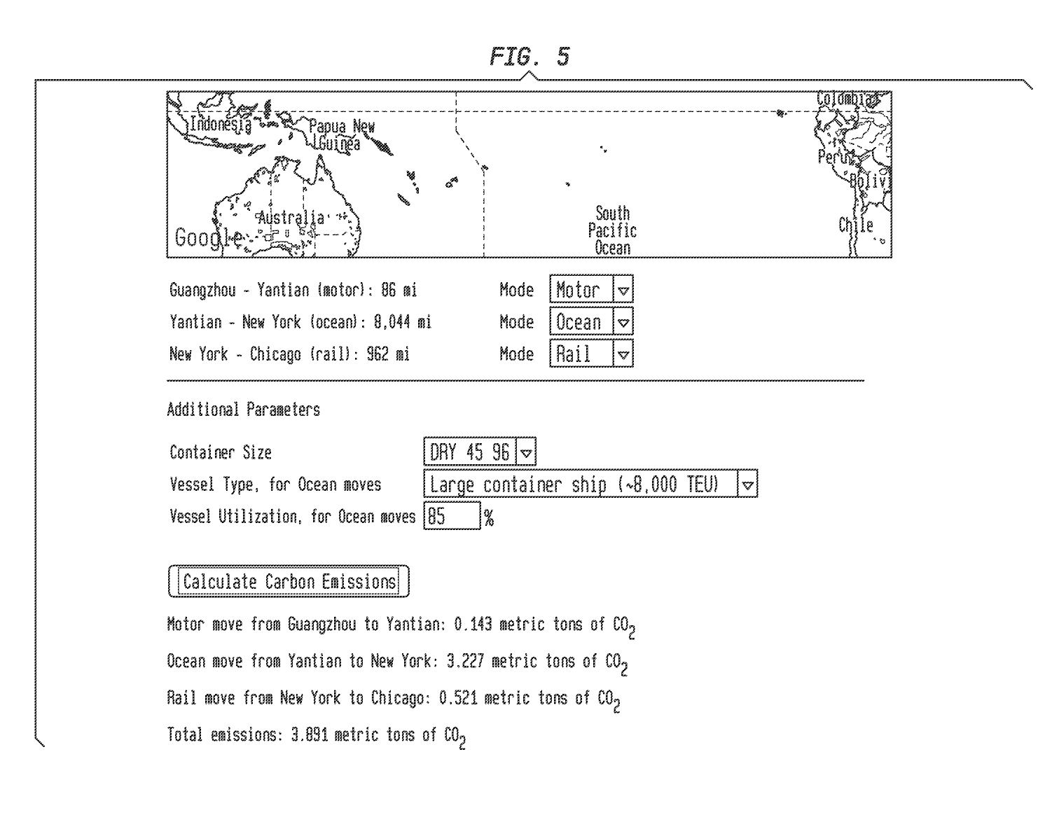

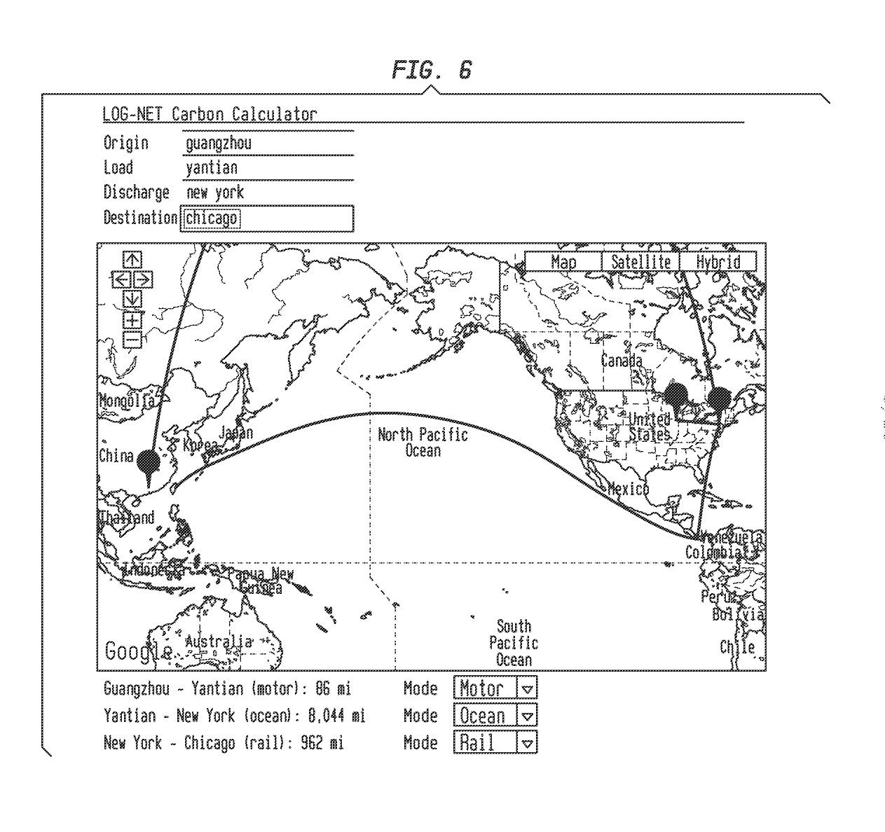

User interfaces in accordance with various aspects of the present invention are illustrated in FIGS. 5 and 6. The user has specified an origin of Guangzhou, an intermediate location of Yantian, another intermediate location of New York and a final destination of Chicago. These legs are displayed below in the map of the world. The mode of transportation is provided to the right of each leg. A drop down list box control is provided next to the label “Mode” next to each leg. When the user click on the arrow in the control, a list of possible modes of transportation are provided. The options are typically Motor (for overland truck transportation), Sea, Air and Rail. The options can be limited in the event one mode of transportation is not available for the route specified.

In this case, the user has selected Motor (or truck transport) for the leg from Guangzhou, China to Yantian, China. The user has selected Ocean transportation for the leg from Yantian, China to New York. The user has selected Rail transportation for the leg from New York to Chicago. The user interface also displays the mileage for each leg.

As shown “Additional Parameters” can also be entered. For example, the container size can be entered. A drop down list box control is provided to enable this entry. A variety of container sizes are provided in the list. The user can also enter the vessel type for ocean moves on the user interface of FIG. 5. Again, a drop down list box control is provided to enable this function. In this case, the user has entered a large container ship. The user can also enter the vessel utilization for ocean moves. As shown in FIG. 5, a text box control is provided to enable this function. In this case, the user has entered an 85% utilization.

Any of the other information mentioned in this application can also be entered. If it is entered, the processor will use that information to calculate carbon emissions for the route entered. Again, if only an origin and destination is entered, the processor can also optionally use the information entered or information in its database to determine the route that will generate the lowest carbon emissions.

When the user wants to determine carbon emissions, the user selects the Calculate Carbon Emissions control button. The processor then calculates the carbon emissions as described herein. The carbon emissions for each leg of the freight transportation is displayed along with the total emissions. In this case, the motor move from Guangzhou to Yantian will generate 0.143 metric tons of CO₂. The ocean move from Yantian to New York will generate 3.227 metric tons of CO₂. The rail move from New York to Chicago will generate 0.521 metric tons of CO₂. The total emissions will be 3,891 metric tons.

The processor can also review alternate routes and/or alternate modes of transportation to determine whether this emission level can be lowered by choosing an alternate route, including intermediate routes, or by choosing an alternate mode of transportation.

FIG. 6 illustrates another possible user interface. The user can enter an origin, a load, a discharge, and a destination in text box controls at the top of the user interface. For each of the routes, a drop down list box is provided under the map of the globe to allow the user to specify the mode of transportation, as described before. Then the user selects a control button (not shown) the carbon emissions for each route is calculated and the route is displayed on the map. In alternate embodiments, the processor can determine the optimal routes and/or modes of transportation for each of the legs selected by the user. Additionally, the processor can determine the optimal routes and/or modes of transportation for the origin and destination selected by the user.

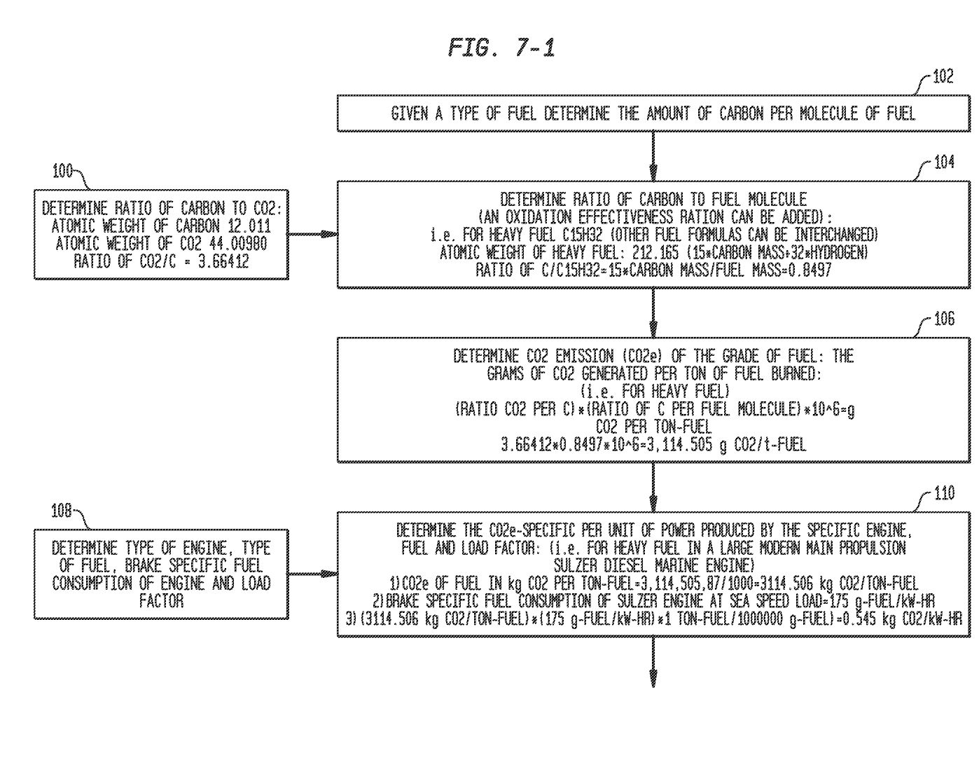

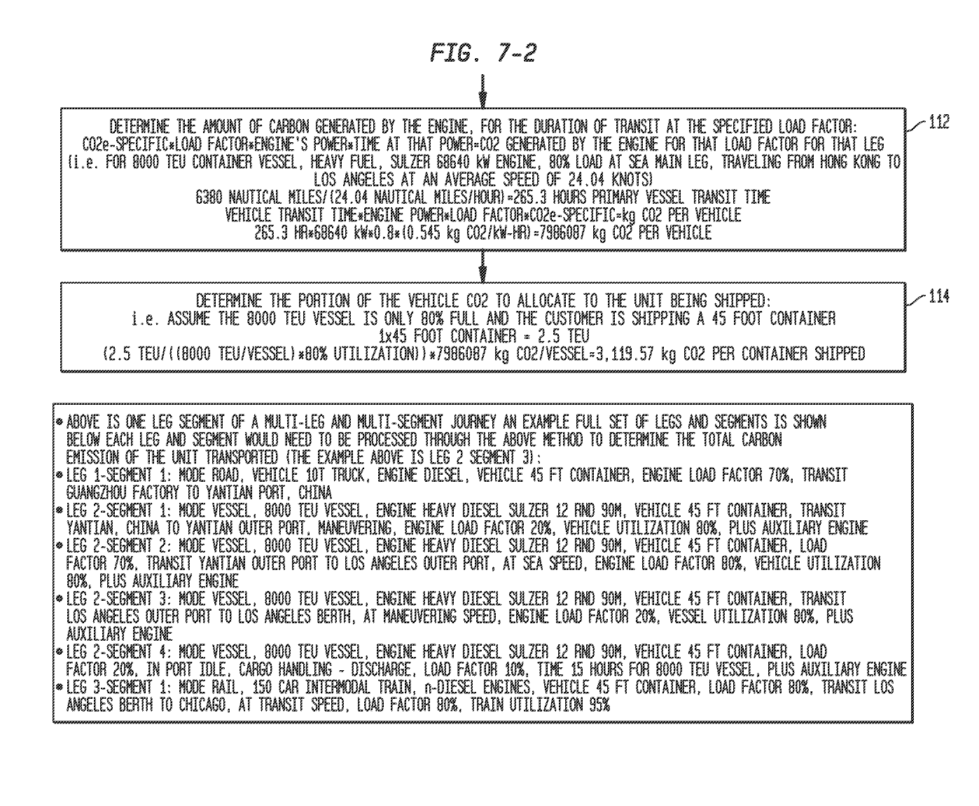

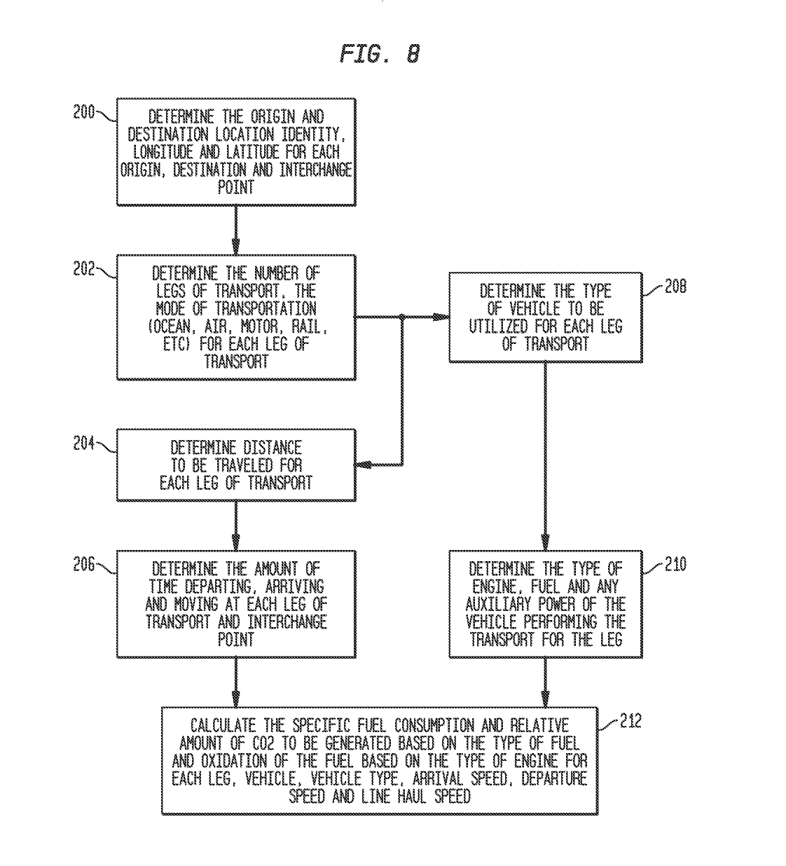

FIGS. 7 and 8 illustrate the steps a processor performs in accordance with one aspects of the present invention. In step 100, for a leg of the transportation that was specified by user or that is being considered as a possibility by the processor, the ratio of carbon to CO₂ is determined. Since the atomic weight of carbon is approximately 12 and the atomic weight of CO₂ is approximately 44, the ration is about 3.66.

In step 102, the type of fuel is considered. Then in step 104, the processor determines the ratio of carbon to the fuel molecule. By way of example, for heavy fuel such as C₁₅H₃₂ the atomic weight is about 212. Then the ratio of carbon to the fuel molecule is about 0.85. An oxidation effectiveness ration can be added. In this way, the ration of carbon to other types of fuels will also be calculated by the processor.

In step 104, the processor determines the ratio of carbon to the fuel molecule. An oxidation effectiveness ratio can be added if desired as well.

In step 106, the processor determines the CO₂ emission for the grade of fuel. It does so by multiplying the ratio of CO₂ to carbon and the ratio of carbon per fuel molecule to determine the CO₂ per ton of fuel, as illustrated in FIG. 7.

In step 108, the processor determines the type of engine and other parameters. For example, the processor considers the brake specific fuel consumption of the engine and the load factor. Manufacturer's test and provide the power rating of their engines at various loads factors of 0% of power through 100% of the rated capacity, typically expressed in break horsepower, of the engine. The engine's design will have different levels of efficiency at each load factor and the rate of fuel consumption at each power level is typically referred to as the break specific fuel consumption (BSFC). While the vehicle may move faster its fuel consumed per unit of power does not improve linearly at high levels of rated capacity and will typically burn more fuel per unit of power at higher load factors making these important variables to consider in carbon emission assessment. This information can be supplied by the user or provided by vehicle or manufacturer reference tables. Alternatively, various possibilities can be considered by the processor based on information in its database.

In step 110, the processor takes the information from step 106 which provided the CO₂ emissions for the grade of fuel and the information from step 108 and determines the CO₂ per unit of power produced by the specified engine, fuel and load factor. The illustration in FIG. 7 shows the calculation for a Sulzer Diesel marine engine using Heavy Fuel.

In step 112, the processor determines the amount of carbon generated by the engine for the duration of transit at the specified load factor. Thus, the processor determines the length of the trip and the average speed to determine the transit time. The transit time is multiplied by the engine power, the load factor and the CO2e to determine the kg of CO₂ emissions per vehicle.

In step 114, the user determines the portion of the CO₂ to allocate to the unit being shipped. Thus, the processor considers the container size and the vehicle that was specified (or if none was specified, the processor can provide its own assumptions). For example, if an 8000 TEU vessel is 80% full and a 45 foot container is being shipped, then a factor of 2.5 TEU (ie a 45 foot container)/8000 TEU container*80% is applied to the results of step 112.

The steps 100 to 114 illustrate the calculations for one leg of a multi-leg transportation. The same calculations can be provided for each leg of the trip. For example, the transport of goods from a factory to the vessel used in the example above may have been on an 18 ton truck powered by a diesel engine moving at 60% of the engines rated capacity. If the truck is moving one container then the emission produced for that truck for its journey from the factory to the port would be completely allocated to the 45 foot container used in the above ocean example. Combining the carbon emissions allocated to the 45 foot container while on the truck and on the vessel would yield the carbon emission allocated to that container for its journey from the factory to the destination port of the vessel. Additional legs can be added to add additional carbon allocation to the container. Information about the items in the container enables the ability to allocate the carbon further to the individual units or the attributes of the units in that container or truck.

FIG. 8 further illustrates the steps the processor takes in accordance with an aspect of the present invention. In step 200, the processor determines the origin and destination identity. This preferably includes determining the longitude and latitude for each origin, destination and interchange point.

In step 202, the processor determines the number of legs of transport and the mode of transport for each leg. As described before, motor, rail, ocean and air modes of transport are considered.

In step 204, the processor determined the distance to be traveled for each leg of transport. In step 206, the processor determines the amount of time departing, arriving and moving at each leg of the transport and at each interchange point. In step 208, the processor determines the type of vehicle to be used for each leg of the transport. In step 210, the processor determines the type of engine, fuel and any auxiliary power the vehicle will need for each leg. In step 212, the processor calculates the specific fuel consumption and relative amount of CO₂ to be generated based on the type of fuel and oxidation of the fuel based on the type of engine for each leg. The processor considers the vehicle type, the arrival speed, departure speed and line haul speed in doing so.

These steps are, in accordance with one aspect of the present invention, performed for each leg of the transportation route specified by the user. These steps are performed for each type of transportation, including land motorized transportation, rail, air and ocean. Where necessary, as explained above, estimates of distances are taken with known methods. In the event the user only specifies origin and destination, the processor can use all of these processor steps considering each variable associated with each mode of transportation for each leg of the route to determine the optimal route in terms of carbon emissions.

The processor can consider a number of possible routes for each leg and select the route with the minimal carbon emissions to assist a company in selecting freight transportation routes with minimal carbon emissions. For each of these permutations, the processor can also select a number of different parameters, as previously described.

It is to be appreciated that this is one example of the steps the processor can take. Other embodiments to implement the calculations previously discussed can also be used.

Various reports that can be generated in accordance with various aspects of the present invention. In accordance with one aspect of the present invention, the steps described above can be repeated for each time freight is transported. The processor can sum the total carbon emissions from each origin and destination for an entity to determine the total carbon emissions, carbon credits or carbon liability of an entity. That sum can be stored in memory and displayed.

The product being transported can also be entered and stored by the user for each freight transfer. Thus, a product is associated with each origin and each destination. The processor can, for an entity, access the product number and determine and display a history of the transportation of the product including the carbon emissions associated with each transportation and the total carbon emissions associated with the transportation of the product over a preselected period of time.

The supplier of the product being transported can also be entered and stored by the user for each freight transfer. Thus, a supplier is associated with each origin and each destination. The processor can, for an entity, access the supplier information and determine and display a history of the transportation related to a preselected supplier's product including the carbon emissions associated with each transportation and the total carbon emissions associated with the transportation of the supplier's product over a preselected period of time.

The system and method of the present invention also stores each leg of a transportation of freight, the mode of transportation used for the leg and determines the carbon emissions associated with each leg and with each mode of transportation. Thus, the processor can access this information and, for each mode of transportation used to transport freight, determine the total carbon emissions.

The carrier providing transportation can also be entered and stored by the user for each freight transfer. If needed, a different carrier can be entered and stored for each leg of the freight transportation. Thus, one or more carriers are associated with each origin and each destination. The processor can, for an entity, access the carrier information and determine and display a history of the transportation related to a preselected carrier product including the carbon emissions associated with carrier over a preselected period of time.

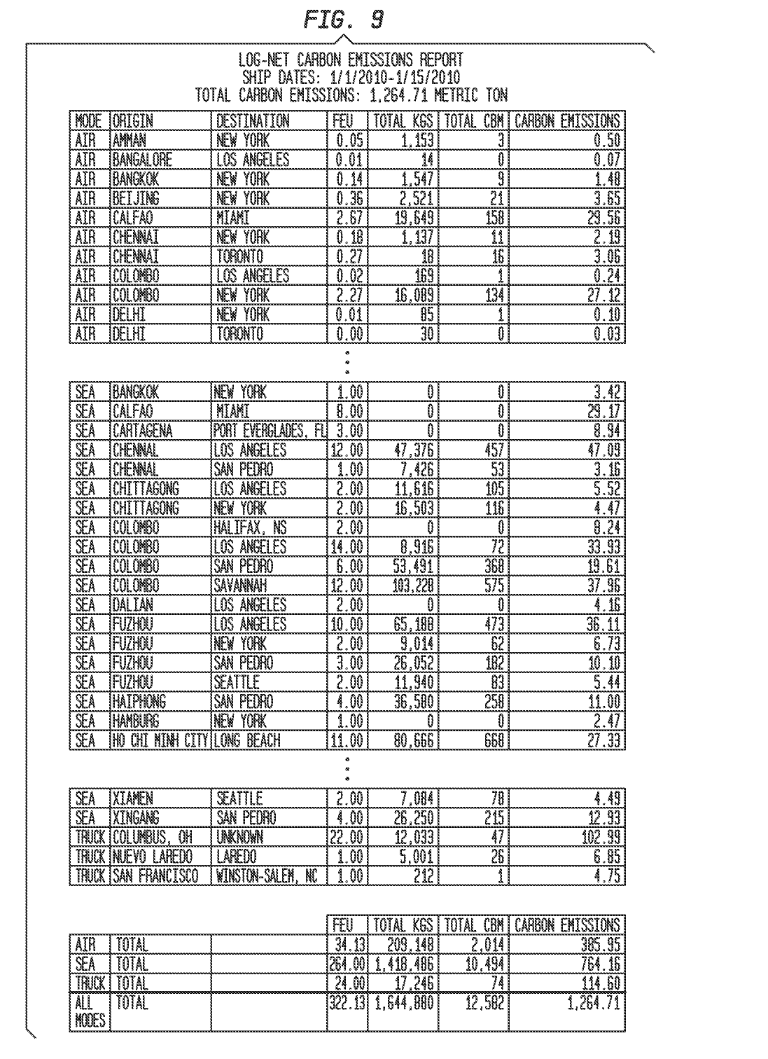

Various reports that can be produced by the processor are illustrated in FIGS. 9 to 14. FIG. 9 shows a total carbon emissions report for an entity for a preselected period of time. The time period of interest and, if necessary, the entity of interest are entered. The processor examines its memory for all transportations of freight during the preselected time period and displays each individual freight transport, including the origin and destination. Also illustrated are Forty Foot Equivalent (FEU) transport units, Total weight in kilograms (KGS), Total volume in cubic meters (CBM) and carbon emissions for each transport. The total carbon emissions for the entity over the preselected period of time is also displayed. In this case the total is 1,264.71 metric tons. The report of FIG. 9 also categorizes total carbon emissions for air, sea and truck, as shown.

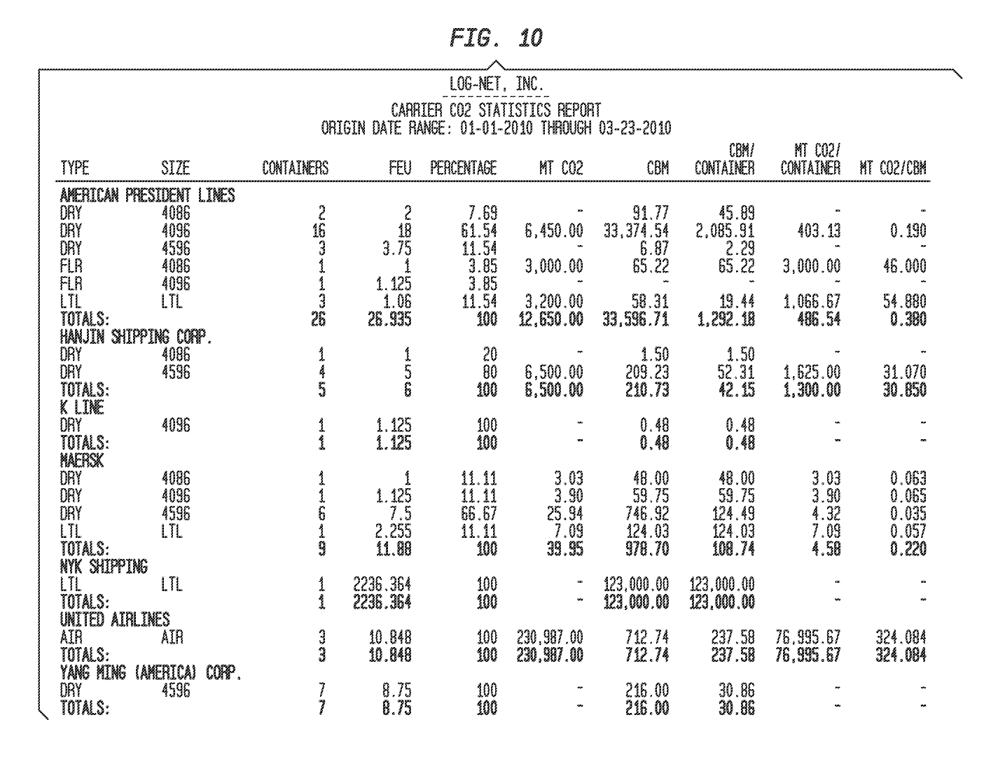

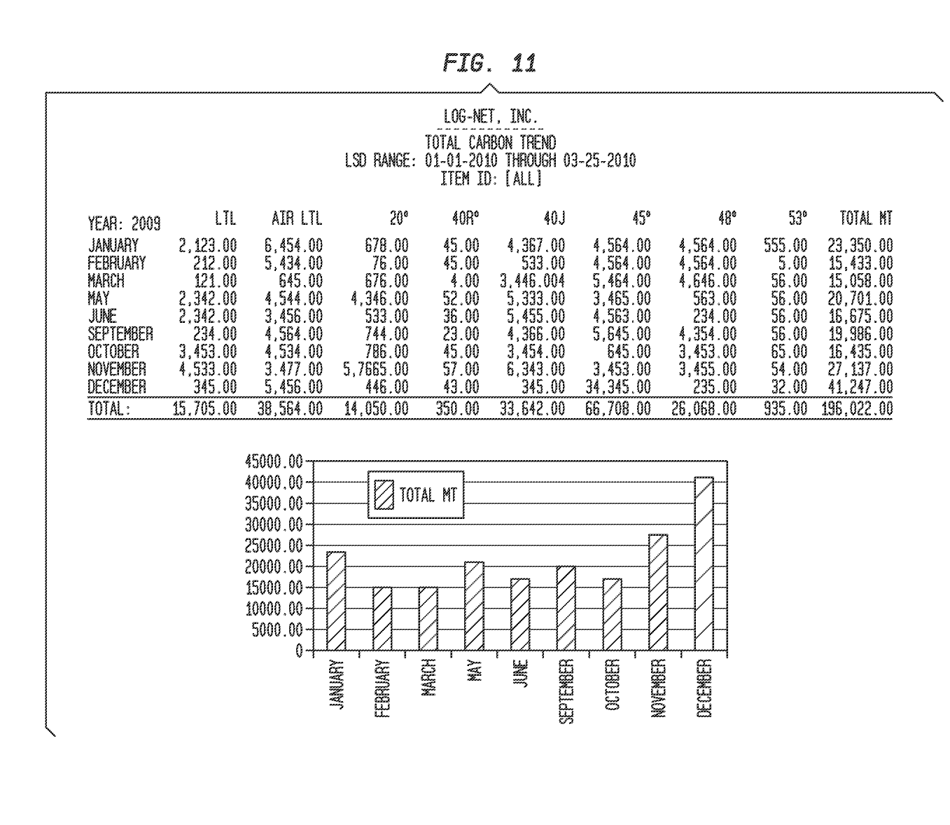

FIG. 10 illustrates a report showing carrier carbon emission statistics for a selected entity for a selected time period. FIG. 11 illustrates a trend study. It shows, for a selected entity over a selected period of time, the monthly carbon emissions by type of transportation. The trend is graphed to provide additional insight into carbon emission trends for a company.

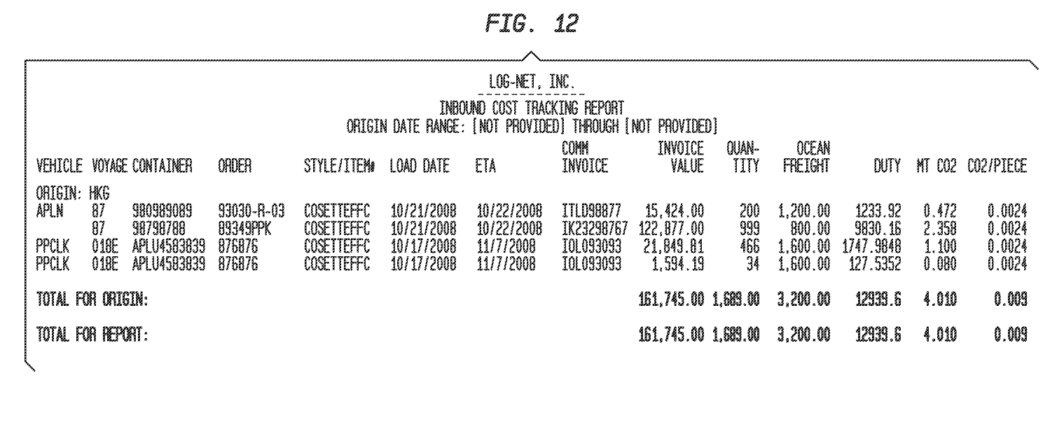

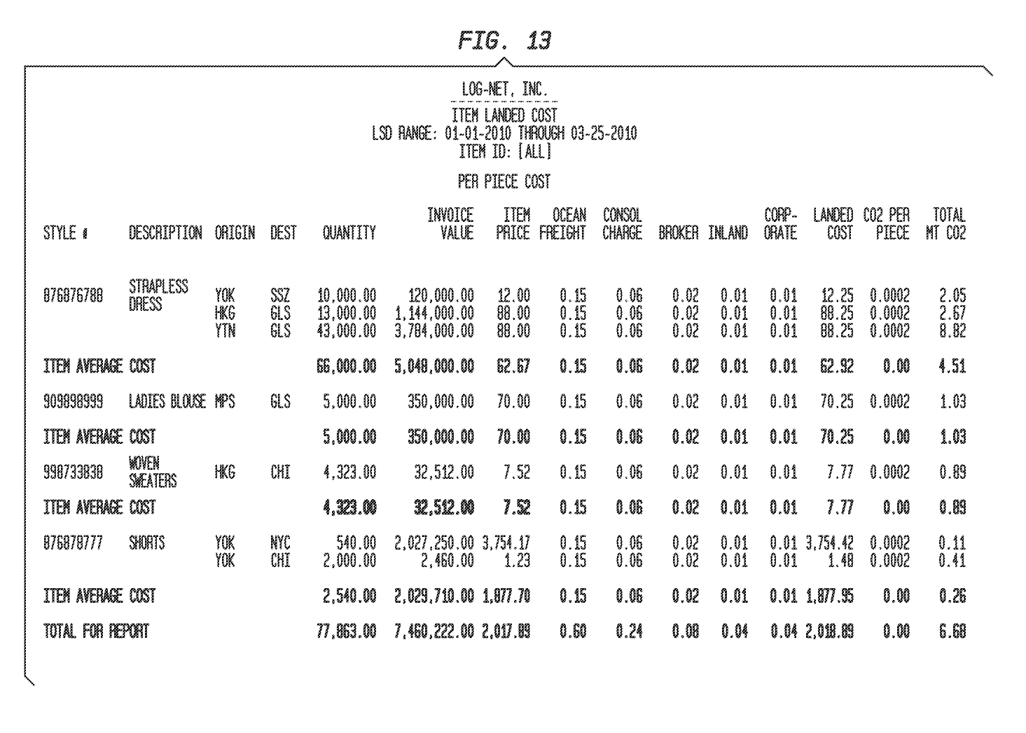

FIG. 12 shows an inbound cost tracking report for an entity. This shows the number of units presently moving to a destination and the carbon emission being expended for each unit of transport. FIG. 13 shows an item landed cost report. The report calculates the average expense in dollars and carbon emission of moving a good from its source to its point of consumption.

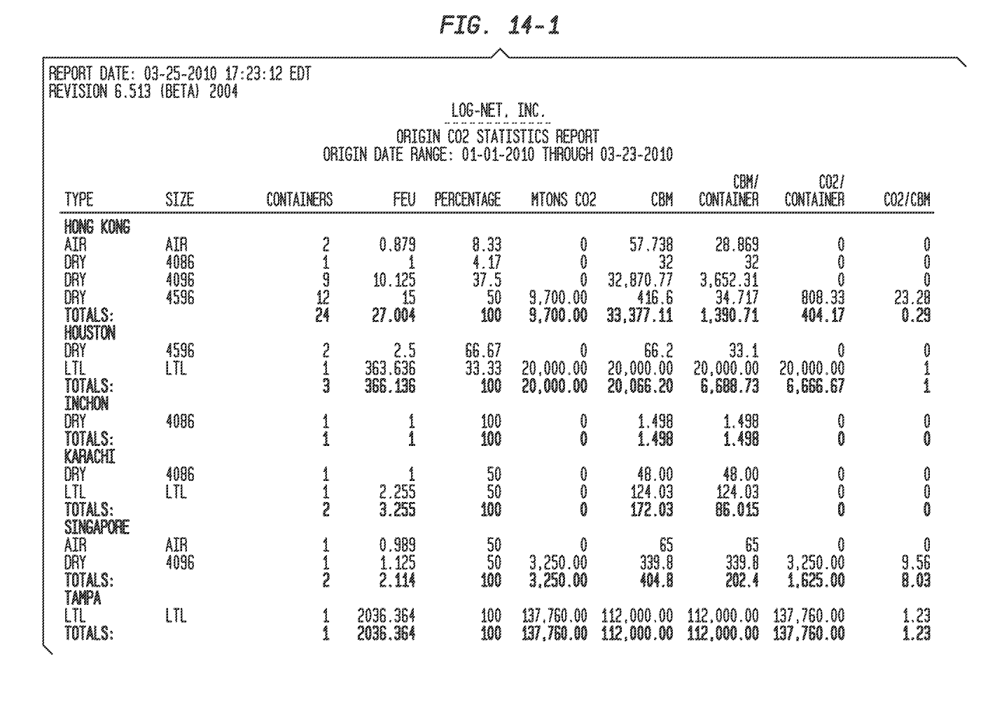

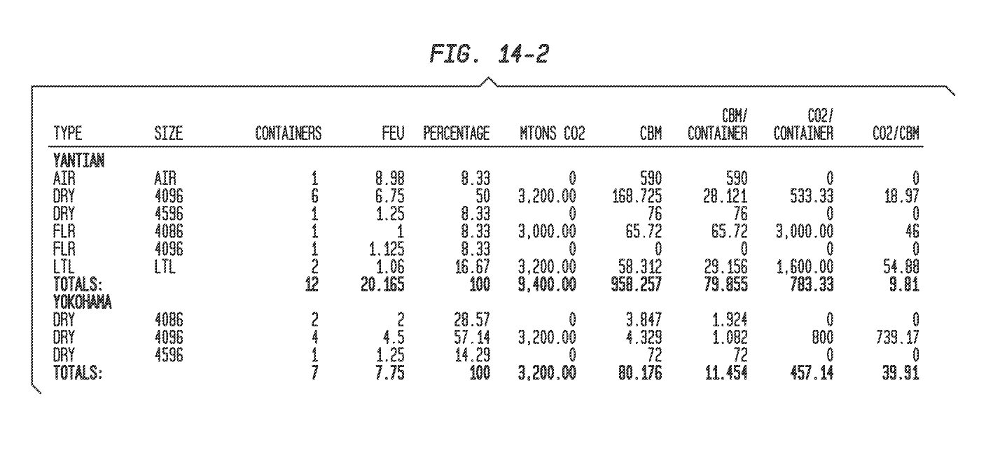

FIG. 14 shows an origin carbon emissions report. For a selected entity over a select time, the processor accesses its database of freight transportation information and determines, for each origin, the displayed information. This

Of course, a variety of reports can be generated using the information provided herein.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims appended hereto.

We claim:

1. A method of calculating carbon emissions, carbon credits and carbon liabilities when transporting a freight, comprising:
entering an origin and a destination on a computer interface;
storing the origin and the destination in a memory;
a processor reading the origin and the destination in the memory and determining carbon emissions when transporting the freight from the origin to the destination by considering a plurality of modes of transporting the freight; and
determining which of the plurality of modes of transporting the freight will generate the least carbon emission.

2. The method of claim 1, comprising displaying the mode of transporting the freight that will generate the least carbon emission.

3. The method of claim 2, wherein the plurality of modes of transporting the freight includes motorized land transportation, ocean transportation, rail transportation and air transportation.

4. The method of claim 3, wherein the processor determines carbon emissions for a plurality of possible routes from the origin to the destination using at least two of the plurality of modes of transporting the freight for each of the plurality of possible routes and then determines which of the plurality of possible routes will generate the least carbon emission.

5. The method of claim 4, comprising:
entering a load and discharge location on the computer interface and storing the load and discharge location in the memory; and
the processor using the load and discharge location to determine carbon emissions for the plurality of possible routes from the origin to the destination using at least two of the plurality of modes of transporting the freight for each of the plurality of possible routes and then determines which of the plurality of possible routes will generate the least carbon emission using the load and discharge location.

6. The method of claim 5, comprising:
repeating the steps of claim 1 for one or more additional origins and destinations;
summing the total carbon emissions from each origin and destination; and
displaying the total carbon emissions.

7. The method of claim 5, comprising the processor considering vessel type, fuel used, arrival time and departure time for each of the plurality of routes to determine which route will generate the least carbon emissions.

8. The method of claim 7, comprising the processor considering time in port when considering ocean transportation.

9. The method of claim 6, comprising the processor determining a total carbon emissions by an entity.

10. The method of claim 6, comprising entering and storing a product associated with each origin and destination and determining the total carbon emission by product over a period of time.

11. The method of claim 6, comprising entering and storing a supplier associated with each origin and destination and determining the total carbon emission by supplier over a period of time.

12. The method of claim 6, comprising determining the total carbon emission by mode of transportation over a period of time.

13. The method of claim 6, comprising entering and storing a carrier associated with each origin and destination and determining the total carbon emission by carrier over a period of time.

14. A system for of calculating carbon emissions when transporting a freight, comprising:
a display;
a memory;
a processor;
application software resident on the memory and operable on the processor, whereby the processor;
causes a user interface to be displayed on the display to allow entry of an origin and a destination on a computer interface;
causes the origin and the destination entered on the computer interface to be stored in the memory;
uses the origin and the destination to determine carbon emissions when transporting the freight from the origin to the destination by considering a plurality of modes of transporting the freight; and
determines which of the plurality of modes of transporting the freight will generate the least carbon emission.

15. The system of claim 14, wherein the mode of transporting the freight that will generate the least carbon emission is displayed on the display.

16. The system of claim 15, wherein the plurality of modes of transporting the freight includes motorized land transportation, ocean transportation, rail transportation and air transportation.

17. The system of claim 16, wherein the processor determines carbon emissions for a plurality of possible routes from the origin to the destination using at least two of the plurality of modes of transporting the freight for each of the plurality of possible routes and then determines which of the plurality of possible routes will generate the least carbon emission.

18. The system of claim 17, wherein a load and discharge location are entered on the computer interface and stored in the memory and the processor uses the load and discharge location to determine carbon emissions for the plurality of possible routes from the origin to the destination using at least two of the plurality of modes of transporting the freight for each of the plurality of possible routes and then determines which of the plurality of possible routes will generate the least carbon emission using the load and discharge location.

19. The system of claim 18, wherein the processor repeats the steps set forth in claim 14 for one or more additional origins and destinations, sums the total carbon emissions from each origin and destination and stores the sum in the memory.

20. The system of claim 14, comprising the processor considering vessel type, fuel used, arrival time and departure time for each of the plurality of routes to determine which route will generate the least carbon emissions or to calculate the actual carbon emission, carbon credit or carbon liability of an entity.

21. The system of claim 20, comprising the processor considering a set of transport units, containers, trucks of other transport methods to determine a total carbon emission, carbon credit or carbon liability for a set of more than one transport units and their associated statistical reports.
